(19) United States
(12) Patent Application Publication
(10) Pub. No.: US 2012/0088163 A1
(43) Pub. Date: Apr. 12, 2012

(54) LITHIUM ION CONDUCTOR, METHOD OF PREPARING THE SAME, AND LITHIUM AIR BATTERY INCLUDING THE LITHIUM ION CONDUCTOR

(75) Inventors: Young-gyoon RYU, Suwon-si (KR); Woo-sung Jeon, Suwon-si (KR); Dong-Joon Lee, Seoul (KR); Yasuo Takeda, Tsu City (JP); Osamu Yamamoto, Tsu City (JP); Nobuyuki Imanishi, Tsu City (JP)

(73) Assignees: National University Corporation Mie University, Tsu City (JP); Samsung Electronics Co., Ltd., Suwon-si (KR)

(21) Appl. No.: 13/195,890

(22) Filed: Aug. 2, 2011

(30) Foreign Application Priority Data
Oct. 8, 2010 (KR) 10-2010-0098343

(51) Int. Cl. H01M 12/06; H01B 1/06

(52) U.S. Cl. 429/405; 252/519.12

(57) ABSTRACT

A lithium ion conductor, a method of preparing the same, and a lithium air battery including the lithium ion conductor. The lithium ion conductor includes a phosphorus-based compound having a characteristic peak at a Raman shift of about 720˜770 cm⁻¹ on a Raman spectrum of the phosphorus-based compound.

### CROSS-REFERENCE TO RELATED APPLICATION

This application claims the benefit of Korean Application No. 10-2010-0098343, filed Oct. 8, 2010 in the Korean Intellectual Property Office, the disclosure of which is incorporated herein by reference.

### BACKGROUND

1. Field

Aspects of the present disclosure relate to a lithium ion conductor, a method of preparing the same, and a lithium air battery including the lithium ion conductor. More particularly, aspects of the present disclosure relate to a lithium ion conductor with improved lithium ion conduction characteristics, a method of preparing the same, and a lithium air battery including the lithium ion conductor.

2. Description of the Related Art

Recently, a great deal of research has been conducted in academic institutions and industry to develop high-energy density battery systems for electric vehicles, increasingly focusing on lithium air batteries, which are known to have the highest theoretical energy density among various batteries.

Lithium air batteries have a theoretical energy density of 3,000 Wh/kg or greater, which is equivalent to about ten times that of lithium ion batteries. Furthermore, due to being environmentally friendly and safer in use than lithium ion batteries, lithium air batteries are increasingly being developed.

A lithium air battery includes a positive electrode (oxygen electrode), a negative electrode (lithium metal), and an electrolyte. When the lithium air battery is operated, release (during charge) and reception (during discharge) of lithium ions occur in the negative electrode, while reduction (during discharge) and release (during charge) of oxygen occur in the positive electrode.

Repeated reception and release of lithium causes formation of lithium dendrites on the surface of the negative electrode, remarkably deteriorating life span and stability of the battery. Due to structural characteristics of the lithium air battery, the lithium air battery is vulnerable to external air and impurities, and thus the negative electrode may deteriorate due to reactions with the external air and impurities.

In order to address this drawback, a great deal of research is being performed on a protective film for protecting the surface of the negative electrode from oxygen, impurities, and electrolytes, and in particular, to improve lithium ion conduction characteristics and mechanical characteristics of the protection film.

### SUMMARY

An aspect of the present invention is a lithium ion conductor with improved lithium ion conduction characteristics.

Another aspect of the present invention is a method of preparing the lithium ion conductor.

Another aspect of the present invention is a lithium air battery including the lithium ion conductor.

According to an aspect of the present invention, a lithium ion conductor includes a phosphorus-based compound having a characteristic peak at a Raman shift of about 720˜770 cm⁻¹ on a Raman spectrum of the phosphorus-based compound.

The phosphorus-based compound may include a glass-ceramic represented by Formula 1 below or a material derived from the glass-ceramic:

Li_{1+x+y}(Ti,Ge)₂₋ₓ(Al,Ga)ₓSi_{y}P_{3-y}O₁₂, Formula 1

wherein, in Formula 1, 0≦x≦1, 0≦y≦1.

According to an aspect of the present invention, a method of preparing a lithium ion conductor includes contacting a phosphorus-based compound with a lithium halide solution.

The phosphorus-based compound may be represented by Formula 1 above. The lithium halide solution may include an aqueous solution of a lithium halide.

The lithium halide in the lithium halide solution may include at least one compound selected from the group consisting of lithium fluoride (LiF), lithium chloride (LiCl), lithium bromide (LiBr), and lithium iodide (Lil).

The concentration of the lithium halide in the lithium halide solution may be from about 0.001 M to the corresponding saturation point.

The contact of the phosphorus-based compound with the lithium halide solution may be performed at a temperature of about 0° C. to about the boiling point of the lithium halide solution.

According to another aspect of the present invention, a lithium air battery includes: a negative electrode receiving and releasing lithium ions; a positive electrode using oxygen as a positive active material; an electrolyte disposed between the negative electrode and the positive electrode; and the above-described lithium ion conductor disposed between the negative electrode and the electrolyte.

Additional aspects and/or advantages of the invention will be set forth in part in the description which follows and, in part, will be apparent from the description, or may be learned by practice of the presented embodiments.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a cross-sectional view of a lithium air battery according to an embodiment of the present invention;

FIG. 2 is a Nyquist plot of impedances of lithium ion conductors of Example 1 and Comparative Examples 1-2; and

FIG. 3 illustrates Raman spectra of the lithium ion batteries of Example 1 and Comparative Example 1.

### DETAILED DESCRIPTION

Reference will now be made in detail to the present embodiments of the present invention, examples of which are illustrated in the accompanying drawings, wherein like reference numerals refer to the like elements throughout. The embodiments are described below, by referring to the figures in order to explain the present invention by referring to the figures.

Hereinafter, embodiments of a lithium ion conductor, a method of preparing the same, and a lithium air battery including the lithium ion conductor according to the present invention will be described in detail.

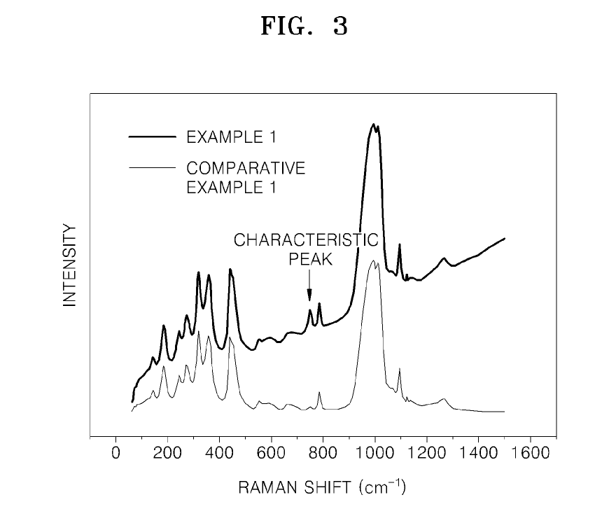

According to an exemplary embodiment of the present invention, a lithium ion conductor includes a phosphorus-based compound having a characteristic peak (see FIG. 3) at a Raman shift of about 720˜770 cm⁻¹ on Raman spectra.

The phosphorus-based compound includes a low amount of a high-resistance component at grain boundaries. Thus, the lithium ion conductor including the phosphorus-based compound may have good lithium ion conduction characteristics. The term ‘grain boundary’ as used herein means interfaces between two grains or crystals in a polycrystalline phosphorus-based compound.

The phosphorus-based compound may include a glass-ceramic represented by Formula 1 below, or may be derived therefrom:

Li_{1+x+y}(Ti,Ge)₂₋ₓ(Al,Ga)ₓSi_{y}P_{3-y}O₁₂, Formula 1

In Formula 1, 0≦x≦1 and 0≦y≦1, and in some embodiments, 0≦x≦0.4 and 0<y≦0.6, and in some other embodiments, 0.1≦x≦0.3 and 0.1<y≦0.4.

The term ‘glass-ceramic’ as used herein refers to a material obtained by thermally treating glass to educe crystalline phases from glass phases in the glass, wherein the glass-ceramic has crystalline solid phases, and, if needed, amorphous solid phases. An example of the glass-ceramic is a material completely phase-transitioned from glass phases to crystalline phases, for example, a material of which the degree of crystallization corresponds to 100 wt % based on the total weight of the material.

The larger the amount of the glass-ceramic in the lithium ion conductor, the higher the ionic conductivity of the lithium ion conductor. The glass-ceramic may be 80 wt % or greater of the lithium ion conductor, based on the total weight of the lithium ion conductor, and in some embodiments, 85% wt % or greater of the lithium ion conductor, and in some other embodiments, 90 wt % or greater of the lithium ion conductor.

A Li₂O component in the glass-ceramic may act as a Li⁺ ion carrier. To provide the glass-ceramic with good ionic conductivity, the Li₂O component may be 12 wt % or greater of the glass-ceramic, based on the total weight of the glass-ceramic, and in some embodiments, 13 wt % or greater of the glass-ceramic, and in some other embodiments, 14 wt % or greater of the glass-ceramic. However, if the amount of the Li₂O component in the glass-ceramic is too large, the thermal stability of the glass phases may be diminished, and the ionic conductivity of the glass-ceramic may be reduced. For these reasons the Li₂O component may be 18 wt % or less of the glass-ceramic, based on the total weight of the glass-ceramic, and in some embodiments, 17 wt % or less of the glass-ceramic, and in some other embodiments, 16 wt % or less of the glass-ceramic.

An Al₂O₃ component in the glass-ceramic may improve the thermal stability of glass phases and the ionic conductivity of the glass-ceramic. The Al₂O₃ component may be 5 wt % or greater of the glass-ceramic, based on the total weight of the glass-ceramic, and in some embodiments, 5.5 wt % or greater of the glass-ceramic, and in some other embodiments, 6 wt % or greater of the glass ceramic. However, if the amount of the Al₂O₃ component in the glass-ceramic is too large, the thermal stability of the glass phases may be diminished, and the ionic conductivity of the glass-ceramic may be reduced. For these reasons the Al₂O₃ component may be 10 wt % or less of the glass-ceramic, based on the total weight of the glass-ceramic, and in some embodiments, 9.5 wt % or less of the glass-ceramic, and in some other embodiments, 9 wt % or less of the glass-ceramic.

A TiO₂ component in the glass-ceramic is useful in forming glass phases, and is also a component of crystalline phases. The TiO₂ component may be 35 wt % or greater of the glass-ceramic, based on the total weight of the glass-ceramic, and in some embodiments, 36 wt % or greater of the glass-ceramic, and in some other embodiments, 37 wt % or greater of the glass-ceramic. However, if the amount of the TiO₂ component in the glass-ceramic is too large, the thermal stability of glass phases may be diminished, and the ionic conductivity of the glass-ceramic may be reduced. For these reasons the TiO₂ component may be 45 wt % or less of the glass-ceramic, based on the total weight of the glass-ceramic, and in some embodiments, 43 wt % or less of the glass-ceramic, and in some other embodiments, 42 wt % or less of the glass-ceramic.

A SiO₂ component in the glass-ceramic may improve the thermal stability of glass phases and the lithium ion conductivity of the glass-ceramic. The SiO₂ component may be 1 wt % or greater of the glass-ceramic, based on the total weight of the glass-ceramic, and in some embodiments, 2 wt % or greater of the glass-ceramic, and in some other embodiments, 3 wt % or greater of the glass-ceramic. However, if the amount of the SiO₂ component in the glass-ceramic is too large, the ionic conductivity of the glass-ceramic may be reduced. For these reasons the SiO₂ component may be 10 wt % or less of the glass-ceramic, based on the total weight of the glass-ceramic, and in some embodiments, 8 wt % or less of the glass-ceramic, and in some other embodiments, 7 wt % or less of the glass-ceramic.

A P₂O₅ component in the glass-ceramic is useful in forming glass phases, and is also a component of crystalline phases. The P₂O₅ component may be 30 wt % or greater of the glass-ceramic, based on the total weight of the glass-ceramic, and in some embodiments, 32 wt % or greater of the glass-ceramic, and in some other embodiments, 33 wt % or greater of the glass-ceramic. However, if the amount of the P₂O₅ component in the glass-ceramic is too large, it may be difficult for crystalline phases to be formed and for the glass-ceramic to have desired characteristics. For these reasons the P₂O₅ component may be 40 wt % or less of the glass-ceramic, based on the total weight of the glass-ceramic, and in some embodiments, 39 wt % or less of the glass-ceramic, and in some other embodiments, 38 wt % or less of the glass-ceramic.

In some embodiments the lithium ion conductor may further include a glass-ceramic including a trace of a component that may lower the melting point or improve the stability of glass phases without a remarkable reduction in lithium ion conductivity.

The lithium ion conductor having the construction as described above covers the surface of a negative electrode in which reception and release of lithium ions take place to protect the negative electrode from reacting with an electrolyte, to block air and impurities. The lithium ion conductor on the surface of the negative electrode passes only lithium ions.

Embodiments of methods of preparing the lithium ion conductor described above will now be described in detail.

According to an exemplary embodiment of the present invention, a method of preparing the lithium ion conductor includes contacting a phosphorus-based compound with a lithium halide solution.

The phosphorus-based compound used in the method of preparing the lithium ion conductor may be a glass-ceramic that is represented by Formula 1 above, but does not have a characteristic peak at a Raman shift of about 720-770 cm⁻¹ on Raman spectra.

The lithium halide solution may improve defect structures such as a high-resistance component at the grain boundaries of the phosphorus-based compound. In particular, the lithium halide solution may effectively react with the high-resistance component, for example, to dissolve the component.

In some embodiments the lithium halide solution may be an aqueous solution of a lithium halide.

The lithium halide may include at least one compound selected from the group consisting of lithium fluoride (LiF), lithium chloride (LiCl), lithium bromide (LiBr), and lithium iodide (Lil).

In the lithium halide solution, the concentration of the lithium halide may be from about 0.001 M to the corresponding saturation point. The term ‘saturation point’ as used herein means the concentration of the lithium halide calculated from the maximum amount of the lithium halide that is dissolvable in a certain solvent under given conditions, such as the temperature of the lithium halide solution and the chemical properties of related components.

The contact of the phosphorus-based compound with the lithium halide solution may be performed at a temperature of about 0° C. to about the boiling point of the lithium halide solution. If the temperature at which the phosphorus-based compound and the lithium halide solution are maintained in contact is within this range, the lithium halide may uniformly react with the high-resistance component of the phosphorus-based compound without causing unnecessary side reactions.

The phosphorus-based compound and the lithium halide solution may be maintained in contact until the high-resistance component in the phosphorus-based compound and the lithium halide sufficiently react with each other.

In some embodiments the contacting of the phosphorus-based compound and the lithium halide solution may be achieved by immersing the phosphorus-based compound in the lithium halide solution in a container.

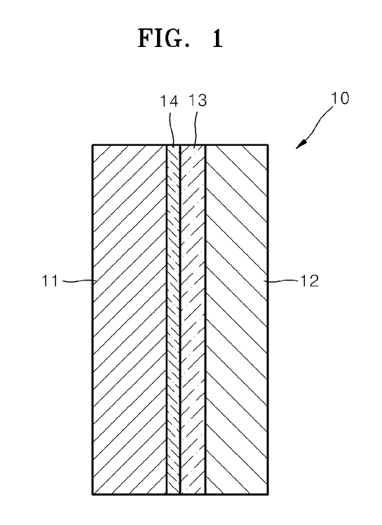

According to another exemplary embodiment of the present invention, a lithium air battery includes the lithium ion conductor described above. Embodiments of the lithium air battery will now be described in detail with reference to FIG. 1.

FIG. 1 is a cross-sectional view of a lithium air battery 10 according to an embodiment of the present invention. Referring to FIG. 1, the lithium air battery 10 includes a negative electrode 11, a positive electrode 12, an electrolyte 13, and a lithium ion conductor 14.

The negative electrode 11 may receive and release lithium ions. The negative electrode 11 may include at least one material selected from the group consisting of lithium metal, a lithium metal-containing alloy, and a lithium intercalation compound. Suitable lithium metal-containing alloys include alloys of aluminum (Al), tin (Sn), magnesium (Mg), indium (In), calcium (Ca), titanium (Ti), vanadium (V), and combinations thereof with lithium metal.

The positive electrode 12 may include any porous and conductive material, and in some embodiments, may include a porous carbonaceous material. Suitable carbonaceous materials include carbon blacks, graphites, graphenes, activated carbons, carbon fibers, and combinations thereof. The positive electrode 12 may further include a catalyst for reducing oxygen. Suitable catalysts may include precious metal-based catalysts, such as platinum (Pt), gold (Au), silver (Ag), palladium (Pd), ruthenium (Ru), rhodium (Rh), and osmium (Os); oxide-based catalysts, such as manganese oxide such as MnO₂, Mn₂O₃ and Mn₃O₄, iron oxide such as Fe₂O₃ and Fe₃O₄, cobalt oxide such as CoO, CoO₂ and CO₃O₄, and nickel oxide such as NiO and Ni₂O₃; organic metal-based catalysts, such as cobalt phthalocyanine; and combinations thereof.

In some embodiments a separator (not shown) may be further disposed between the positive electrode 12 and the lithium ion conductor 14. Any suitable separator may be used as long as it is durable against environments of use of the lithium air battery 10. Suitable separators may include polymer non-woven fabrics, such as polypropylene-based non-woven fabrics and polyphenylene sulfide-based non-woven fabrics; porous films of olefin-based resins, such as polyethylene and polypropylene films; and combinations thereof.

The electrolyte 13 may include at least one of an aqueous electrolyte, a nonaqueous electrolyte, and a solid electrolyte.

The aqueous electrolyte may include a lithium salt, such as lithium hydroxide or lithium halide, dissolved in water.

The nonaqueous electrolyte may include a lithium salt dissolved in an organic solvent, and not in water. Suitable organic solvents may include carbonate-based solvents, ester-based solvents, ether-based solvents, ketone-based solvents, organosulfur-based solvents, organophosphorus-based solvents, aprotic solvents, and combinations thereof. Suitable carbonate-based solvents may include dimethyl carbonate (DMC), diethyl carbonate (DEC), ethylmethyl carbonate (EMC), di-n-propyl carbonate (DPC), methyl-n-propyl carbonate (MPC), ethylpropyl carbonate (EPC), ethylene carbonate (EC), propylene carbonate (PC), fluoroethylene carbonate (FEC), 1,2-butylene carbonate (BC), cis-2,3-butylene carbonate, trans-2,3-butylene carbonate and combinations thereof. Suitable ester-based solvents may include methyl acetate, ethyl acetate, n-propyl acetate, dimethyl acetate, methyl propionate, ethyl propionate, γ-butyrolactone (GBL), 5-decanolide, γ-valerolactone, dl-mevalonolactone, γ-caprolactone, and combinations thereof. Suitable ether-based solvents may include dibutyl ether, tetraglyme, diglyme, dimethoxyethane, 2-methyltetrahydrofuran, tetrahydrofuran, and combinations thereof. A suitable ketone-based solvent may be cyclohexanone. Suitable organosulfur-based and organophosphorus-based solvents may include methane sulfonylchloride, p-trichloro-n-dichlorophosphorylmonophosphagen, and combinations thereof. Suitable aprotic solvents may include: nitriles, such as R—CN (wherein R is a C₂-C₂₀ linear, branched, or cyclic hydrocarbon-based moiety that may include a double-bonded aromatic ring or an ether bond); amides, such as dimethylformamide; dioxolanes, such as 1,3-dioxolane; sulfolanes; and combinations thereof.

The lithium salt of the nonaqueous electrolyte is dissolved in the organic solvent and then acts as a source of lithium ions for the lithium air battery 10. The lithium salt may facilitate migration of lithium ions between the negative electrode 11 and the lithium ion conductor 14. Suitable lithium salts for the nonaqueous electrolyte include, for example, at least one supporting electrolyte salt selected from the group consisting of LiPF₆, LiBF₄, LiSbF₆, LiAsF₆, LiN (SO₂C₂F₅)₂, Li (CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂) (where x and y are each a natural number), LiF, LiBr, LiCl, Lil, and LiB (C₂O₄)₂ (lithium bis(oxalato) borate or LiBOB), and combinations thereof. The nonaqueous electrolyte may further include another metal salt, in addition to the lithium salt. Suitable other metal salts may include AlCl₃, MgCl₂, NaCl, KCl, NaBr, KBr, CaCl₂, and combinations thereof.

In some embodiments the solid electrolyte may include boron oxide, lithium oxynitride, a solid polymer electrolyte (SPE), or a combination thereof. Any suitable solid polymer electrolyte may be used as long as it is durable against environments of use of the lithium air battery 10. A suitable solid polymer electrolyte may be polyethylene oxide doped with a lithium salt. Suitable lithium salts that may be used in preparing solid polymer electrolytes may include LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and combinations thereof.

The lithium ion conductor 14 may be the lithium ion conductor described above. The lithium ion conductor 14 may protect the negative electrode 11 from oxygen and impurities (for examples, H₂O, CO₂, CO, SO_{N}, and NO_{N}) in air, and the electrolyte 13, and may inhibit generation of dendrites on the negative electrode 11, while allowing lithium ions to be passed through.

In some embodiments the lithium ion conductor 14 may further include a solid polymer electrolyte, in addition to the glass-ceramic described above. The solid polymer electrolyte of the lithium ion conductor 14 may be polyethylene oxide doped with a lithium salt. Suitable lithium salts that may be used in preparing solid polymer electrolytes may include LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₆)₂, LiC(SO₂CF₃)₃, LiN(SO₃CF₃)₂, LiC₄F₉SO₃, LiAlCl₄, and combinations thereof.

The solid polymer electrolyte may form a stack structure with the glass-ceramic in the lithium ion conductor 14. In some embodiments the solid polymer electrolyte may be layered on a surface or opposite surfaces of the glass-ceramic, although not illustrated in FIG. 1.

According to the embodiments of the present invention described above, the lithium air battery 10 includes the lithium ion conductor 14 with good lithium ion conducting characteristics, and thus has a high-energy density and high output power, because of reduced overvoltage. The lithium air battery 10 may also have long life span, because of suppressed side reactions between the negative electrode 11 and impurities, air (i.e., oxygen), and the electrolyte 13.

The lithium air battery 10 may be either a lithium primary battery or a lithium secondary battery. The lithium air battery 10 may have any of various shapes, and in some embodiments, may have a shape like a coin, a button, a sheet, a stack, a cylinder, a plane, or a horn. In some embodiments the lithium air battery 10 may be used as a large battery for electric vehicles.

Hereinafter, one or more embodiments of the present disclosure will be described in detail with reference to the following examples. However, these examples are not intended to limit the purpose and scope of the one or more embodiments of the disclosure.

### EXAMPLES

### Comparative Example 1

### Preparation of Lithium Ion Conductor

71.72 g of lithium carbonate (Li₂CO₃), 127.79 g of titanium dioxide (TiO₂), 150.05 g of aluminum nitrate (Al(NO₃)₃), and 345.08 g of (mono)ammonium dihydrogen phosphate (NH₄H₂PO₄) were ground and mixed in a mortar. The resulting mixture was heated at about 1100° C. for 2 hours to obtain a synthesized powder. The synthesized powder was compressed to form ceramic pellets, which were then sintered at about 1100° C. for about 1 hour to prepare a lithium ion conductor.

### Comparative Example 2

### Treatment of Lithium Ion Conductor

The lithium ion conductor prepared in Comparative Example 1 was immersed in an acetic acid solution saturated with lithium acetate at about 50° C. for 7 days.

### Example 1

### Treatment of Lithium Ion Conductor

The lithium ion conductor prepared in Comparative Example 1 was immersed in an aqueous solution saturated with lithium chloride at about 50° C. for 7 days.

### EVALUATION EXAMPLES

### Evaluation Example 1

### Elemental Analysis of Lithium Ion Conductor

Elements of the lithium ion conductors prepared or treated in Comparative Examples 1-2, and Example 1 were analyzed using an ICPS-8100 ICP/AES spectrometer (available from Shimadzu Corp.). As a result, the lithium ion conductors prepared or treated in Comparative Examples 1-2 and Example 1 were identified to be Li_{1.4}Ti_{1.6}Al_{0.4}P₃O₁₂.

### Evaluation Example 2

### Impedance Measurement of Lithium Ion Conductor

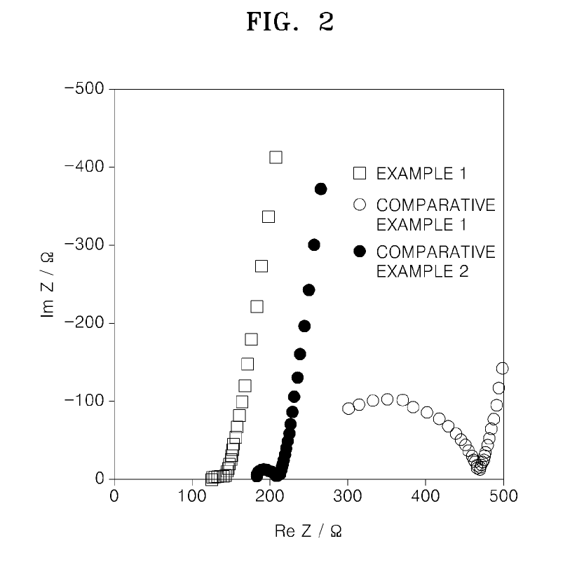

Impedances of the lithium ion conductors prepared or treated in Comparative Examples 1-2, and Example 1 were analyzed. Results are shown in FIG. 2. The device used in the impedance analysis was a Materials Mates 7260 impedance meter (available from Materials Mates). The impedance analysis was performed within a frequency range of about 0.1 Hz to about 1 MHz.

In FIG. 2, Re Z, corresponding to the X-axis, represents resistance, and Im Z, corresponding to the Y-axis, represents impedance. An arc curve (not shown) for each of the lithium ion conductors was obtained by curve-fitting curved plot data on the left-hand part of each plot in FIG. 2, excluding linear plot data on the right-hand part of each plot. The difference between two Re Z points on the X-axis was read as the grain boundary resistance of a lithium ion conductor, and the value of the right-side point of the two Re Z points was read as a total resistance.

Referring to FIG. 2, the lithium ion conductor of Example 1 is lower in both grain boundary resistance and total resistance than the lithium ion conductors of Comparative Examples 1-2. The area specific resistance and electrical conductivity of each of the lithium ion conductors were calculated based on the impedance data of FIG. 2. Results are shown in Table 1 below. The more the electrical conductivity increases, the more the lithium ion conductivity increases.

TABLE 1

| | Area specific resistance | Electrical conductivity |
|---|---|---|
| | (Ω · cm²) | (mS/cm) |
| Example 1 | 13.9 | 2.0 |
| Comparative | 241 | 0.6 |
| Example 1 | | |
| Comparative | 24.3 | 1.3 |
| Example 2 | | |

Referring to Table 1, the lithium ion conductor of Example 1 has an area specific resistance that is about from one twentieth to about a half of those of the lithium ion conductors of Comparative Examples 1-2, and an electrical conductivity that is about two to about three times greater than those of the lithium ion conductors of Comparative Examples 1-2.

### Evaluation Example 3

### Raman Analysis of Lithium Ion Conductor

Raman spectra of the lithium ion conductors prepared or treated in Comparative Example 1 and Example 1 were measured using a Raman spectrometer (in Via Raman Microscope, available from Renishaw). Results are shown in FIG. 3.

Referring to FIG. 3, the lithium ion conductor of Example 1 has a characteristic peak at a Raman shift range of about 720-770 cm⁻¹, which do not appear in the lithium ion conductor of Comparative Example 1.

It should be understood that the exemplary embodiments described herein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A lithium ion conductor comprising a phosphorus-based compound having a characteristic peak at a Raman shift of about 720˜770 cm⁻¹ on a Raman spectrum of the phosphorus-based compound.

2. The lithium ion conductor of claim 1, wherein the phosphorus-based compound is a glass-ceramic represented by Formula 1 below or a material derived from the glass-ceramic:
Li_{1+x+y}(Ti,Ge)₂₋ₓ(Al,Ga)ₓSi_{y}P_{3-y}O₁₂, Formula 1
wherein, in Formula 1, 0≦x≦1, 0≦y≦1.

3. A method of preparing a lithium ion conductor, the method comprising contacting a phosphorus-based compound with a lithium halide solution.

4. The method of claim 3, wherein the phosphorus-based compound is a compound represented by Formula 1 below:
Li_{1+x+y}(Ti,Ge)₂₋ₓ(Al,Ga)ₓSi_{y}P_{3-y}O₁₂, Formula 1
wherein, in Formula 1, 0≦x≦1, 0≦y≦1.

5. The method of claim 3, wherein the lithium halide solution is an aqueous solution of a lithium halide.

6. The method of claim 3, wherein the lithium halide in the lithium halide solution is at least one compound selected from the group consisting of lithium fluoride (LiF), lithium chloride (LiCl), lithium bromide (LiBr), and lithium iodide (Lil).

7. The method of claim 3, wherein the concentration of the lithium halide in the lithium halide solution is from about 0.001 M to the corresponding saturation point.

8. The method of claim 3, wherein the contacting of the phosphorus-based compound with the lithium halide solution is performed at a temperature of about 0° C. to about the boiling point of the lithium halide solution.

9. A lithium air battery comprising:
a negative electrode receiving and releasing lithium ions;
a positive electrode using oxygen as a positive active material;
an electrolyte disposed between the negative electrode and the positive electrode; and
the lithium ion conductor of claim 1 disposed between the negative electrode and the electrolyte.

10. A lithium air battery comprising:
a negative electrode receiving and releasing lithium ions;
a positive electrode using oxygen as a positive active material;
an electrolyte disposed between the negative electrode and the positive electrode; and
the lithium ion conductor of claim 2 disposed between the negative electrode and the electrolyte.
